(19) United States
(12) Patent Application Publication
(10) Pub. No.: US 2010/0304748 A1
(43) Pub. Date: Dec. 2, 2010

(54) Apparatus and Method for Handover in a Communication System

(76) Inventors: Tero Henttonen, Espoo (FI); Lars Dalsgaard, Oulu (FI); Jarkko T. Koskela, Oulu (FI)

Correspondence Address: SLATER & MATSIL, L.L.P., 17950 PRESTON RD, SUITE 1000, DALLAS, TX, 75252-5793, US

(21) Appl. No.: 12/767,140

(22) Filed: Apr. 26, 2010

Related U.S. Application Data
(60) Provisional application No. 61/173,045, filed on Apr. 27, 2009.

(51) Int. Cl. H04W 36/00

(52) U.S. Cl. 455/436

(57) ABSTRACT

An apparatus, method and system for providing management and execution of handover or redirection of user equipment in a communication system. In one embodiment, the apparatus includes a processor and memory including computer program code. The memory and the computer program code are configured to, with the processor, cause the apparatus to receive a command from a source base instructing the apparatus to decode a physical downlink control channel associated with a target base station, and determine if a cell radio network temporary identifier from the source base station matches an assigned cell radio network temporary identifier on the physical downlink control channel from the target base station.

This application claims the benefit of U.S. Provisional Application No. 61/173,045 entitled “System and Method for Network-Assisted Cell Confirmation in Handover in a Communication System,” filed on Apr. 27, 2009, which is incorporated herein by reference.

### TECHNICAL FIELD

The present invention is directed, in general, to communication systems and, in particular, to a system and method to provide handover or redirection of user equipment in a communication system.

### BACKGROUND

Long term evolution (“LTE”) of the Third Generation Partnership Project (“3GPP”), also referred to as 3GPP LTE, refers to research and development involving the 3GPP Release 8 and beyond, which is the name generally used to describe an ongoing effort across the industry aimed at identifying technologies and capabilities that can improve systems such as the universal mobile telecommunication system (“UMTS”). The goals of this broadly based project include improving communication efficiency, lowering costs, improving services, making use of new spectrum opportunities, and achieving better integration with other open standards. The 3GPP LTE project is not itself a standard-generating effort, but will result in new recommendations for standards for the UMTS.

The evolved UMTS terrestrial radio access network (“E-UTRAN”) in 3GPP includes base stations providing user plane (including packet data convergence protocol/radio link control/medium access control/physical (“PDCP/RLC/MAC/PHY”) sublayers) and control plane (including radio resource control (“RRC”) sublayer) protocol terminations towards wireless communication devices such as cellular telephones. A wireless communication device or terminal is generally known as user equipment (“UE”). A base station is an entity of a communication network often referred to as a Node B or an NB. Particularly in the E-UTRAN, an “evolved” base station is referred to as an eNodeB or an eNB. For details about the overall architecture of the E-UTRAN, see 3GPP Technical Specification (“TS”) 36.300, v8.5.0 (2008-05), which is incorporated herein by reference.

As wireless communication systems such as cellular telephone, satellite, and microwave communication systems become widely deployed and continue to attract a growing number of users, there is a pressing need to accommodate a large and variable number of communication devices transmitting a growing range of communication applications with fixed communication resources. An area of incomplete development in such wireless communication systems relates to handover of a mobile station (i.e., user equipment) from one base station to a second base station when the second base station is operating with an access restriction for the user equipment that may prevent completion of the handover.

In the current 3GPP Release 8 specification, the communication network may order handover of user equipment to a cell with an access restriction, for example, a cell that services user equipment in an allowed closed subscriber group (“CSG”) list. The user equipment generally assumes that the communication network has already checked access restrictions and rights and the user equipment is therefore not prepared, for example, for a tracking area update (“TAU”) rejection during a handover process. A tracking area update is a procedure run by a mobility management entity (“MME”) and triggered by user equipment when the user equipment enters a cell in a new tracking area. Access restriction lists (e.g., a list of forbidden location areas for roaming or an allowed closed subscriber group list), are typically maintained by a non-access stratum (“NAS”) of a communication system that handles the necessary bookkeeping for access restriction lists.

When the user equipment identifies a closed subscriber group cell and reports the same to the network, the reported cell is known at the base station by its physical cell identity (“PCI”). The user equipment and network can recognize that a reported cell is a closed subscriber group cell as its physical cell identity falls within a reserved set of physical cell identities known in E-UTRAN as closed subscriber group-physical cell identity range. Due to the limited number of physical cell identities (presently limited to 504 in E-UTRAN, of which part might be reserved for closed subscriber group cells (between 0 and 504)) and due to potential reuse of the physical cell identity number for the closed subscriber group cells within a macro cell, the network cannot always uniquely identify the closed subscriber group cell and thus the base station cannot be certain to which closed subscriber group cell the user equipment is referring. To insure unique identification of a closed subscriber group cell, the user equipment currently listens to a system information broadcast (“SIB”) message containing the global cell identity (“GCI”) and/or a closed subscriber group identity (“CSG-ID”) contained in a SIB one (“SIB 1”) message in an E-UTRAN broadcast by the closed subscriber group cell to verify the global cell identity and/or the closed subscriber group identity, and then inform the network of either one or both of the two parameters.

In an idle communication mode, this may not be a significant problem, but performing this function in an active mode has the clear drawback of either introducing a service interruption due to reading the system information broadcast messages or having reduced handover performance if the network tries to hand over the user equipment to a cell that is not allowed or not prepared by the base station, resulting in a handover failure. Alternatively, the handover of the user equipment to an allowed and accessible closed subscriber group cell is delayed due to delayed closed subscriber group confirmation because the user equipment cannot read the SIB 1 message without interrupting ongoing data flow.

In a process that provides connected-mode mobility for user equipment towards, for example, a closed subscriber group cell in an E-UTRAN network, there is a possibility that the target cell (a closed subscriber group cell) is not uniquely identifiable in the network using the reported physical cell identity. The E-UTRAN mobility in RRC_Connected mode is based on user equipment-assisted network-controlled mobility handover procedures. The network decides on potential target cells using internal rules and cells reported by the user equipment in measurement reports describing communication paths to potential target cells. The user equipment reports, among other data, the physical cell identity of identified cells to enable the source base station/network to identify the reported cells.

A problem arises when the user equipment reports identified closed subscriber group cells. Closed subscriber group cells can be recognized by the user equipment and the network by the fact that the physical cell identity of a closed subscriber group cell is inside a specific range of reserved physical cell identities for the closed subscriber group cells, thereby specifying the closed subscriber group-physical cell identity range. Since the reserved physical cell identity range is limited, it introduces the potential problem of physical cell identity confusion and duplication. The physical cell identity confusion means that the source base station (also referred to as the “serving eNB”) cannot uniquely identify the reported target cell by its physical cell identity. There may be two or more potential target cells with the same reported physical cell identity within a macro cell's (i.e., a cell area including a source or serving cell and other cells such as target cells) coverage area.

Not being able to identify uniquely the reported target cell by the reported physical cell identity raises problems for both the network and the user equipment. A most noticeable problem is that the target cell (identified by the physical cell identity) in the handover may not be unique. This could result in the user equipment and the base station/network targeting two different cells in the handover procedure. The physical cell identity issue may apply to E-UTRAN networks and other types of networks as well such as LTE-advanced (“LTE-A”) networks and may not be restricted to closed subscriber group cells, but could apply to any cell in a communication system.

Thus, a functional and reliable process to manage a handover or redirection of user equipment to a target cell, which is not uniquely identifiable by a serving or source cell, is not known for handling connected-mode mobility to or between closed subscriber group cells or other restricted cells/frequencies/areas due to the limited number of physical cell identities, and the resulting uncertainty of the target closed subscriber group cell. Similar limitations are also present in legacy systems such as UMTS terrestrial radio access (“UTRA”) and global system for mobile communications (“GSM”) based systems for handover or redirection of the user equipment to a target cell with an access restriction for the user equipment.

In view of the growing deployment of communication systems such as cellular communication networks exhibiting a general uncoordinated deployment of cells therein, further improvements are necessary for efficient management of handover or redirection of the user equipment in the communication systems. Therefore, what is needed in the art is a system and method that avoid the deficiencies of known communication systems for management and execution of such handovers or redirections.

### SUMMARY OF THE INVENTION

These and other problems are generally solved or circumvented, and technical advantages are generally achieved, by embodiments of the present invention, which include an apparatus, method and system for providing management and execution of handover or redirection of user equipment in a communication system. In one embodiment, the apparatus includes a processor and memory including computer program code. The memory and the computer program code are configured to, with the processor, cause the apparatus to receive a command from a source base instructing the apparatus to decode a physical downlink control channel associated with a target base station, and determine if a cell radio network temporary identifier from the source base station matches an assigned cell radio network temporary identifier on the physical downlink control channel from the target base station.

In another embodiment, the apparatus includes a processor and memory including computer program code. The memory and the computer program code are configured to, with the processor, cause the apparatus to instruct a target base station to transmit an assigned cell radio network temporary identifier on the physical downlink control channel to a user equipment, and provide a command instructing a user equipment to decode the physical downlink control channel to determine if a cell radio network temporary identifier in the command matches the assigned cell radio network temporary identifier.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawings, in which:

FIGS. 1 and 2 illustrate system level diagrams of embodiments of communication systems including a base station and wireless communication devices that provide an environment for application of the principles of the present invention;

FIGS. 3 and 4 illustrate system level diagrams of embodiments of communication systems including a wireless communication systems that provide an environment for application of the principles of the present invention;

FIG. 5 illustrates a system level diagram of an embodiment of a communication element of a communication system for application of the principles of the present invention;

FIGS. 6 to 8 illustrate system level communication diagrams demonstrating exemplary cases of physical cell identity confusion between a serving or source cell/base station and target cells/base stations;

FIG. 9 illustrates a flow diagram of an embodiment of a sequence of operations performed to execute a handover to a target base station according to the principles of the present invention;

FIG. 10 illustrates a signaling diagram demonstrating exemplary signaling messages between user equipment, a serving or source base station and a target base station during a handover procedure in accordance with the principles of the present invention;

FIG. 11 illustrates a flow diagram of an embodiment of a sequence of operations performed to execute a handover to a target base station according to the principles of the present invention; and

FIG. 12 illustrates a signaling diagram demonstrating exemplary signaling messages between user equipment and a serving or source base station during a handover procedure in accordance with the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. In view of the foregoing, the present invention will be described with respect to exemplary embodiments in a specific context of a system and method for management and execution of handover of user equipment to a target cell with an access restriction.

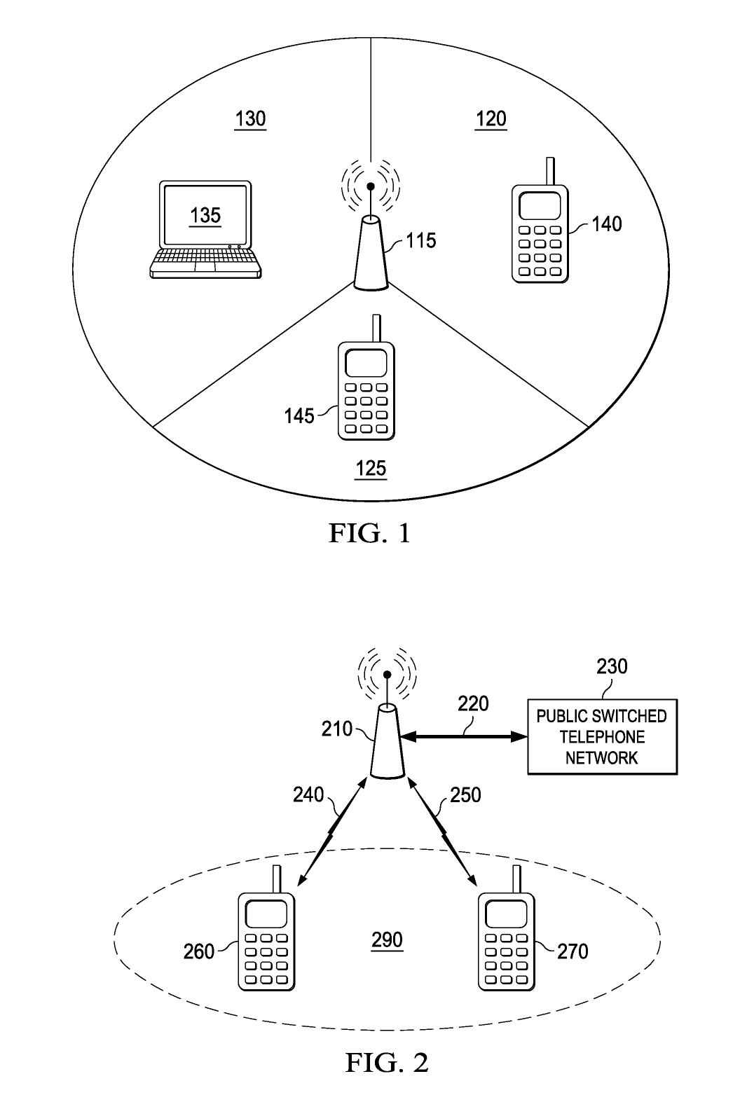

Turning now to FIG. 1, illustrated is a system level diagram of an embodiment of a communication system including a base station 115 and wireless communication devices (e.g., user equipment) 135, 140, 145 that provides an environment for application of the principles of the present invention. The base station 115 is coupled to a public switched telephone network (not shown). The base station 115 is configured with a plurality of antennas to transmit and receive signals in a plurality of sectors including a first sector 120, a second sector 125, and a third sector 130, each of which typically spans 120 degrees. The sectors are formed by focusing and phasing the radiated and received signals from the base station antennas. The plurality of sectors increases the number of subscriber stations (e.g., the wireless communication devices 135, 140, 145) that can simultaneously communicate with the base station 115 without the need to increase the utilized bandwidth by reduction of interference that results from focusing and phasing base station antennas. The radiated and received frequencies utilized by the communication system illustrated in FIG. 1 would typically be two gigahertz to provide non-line-of-sight communication.

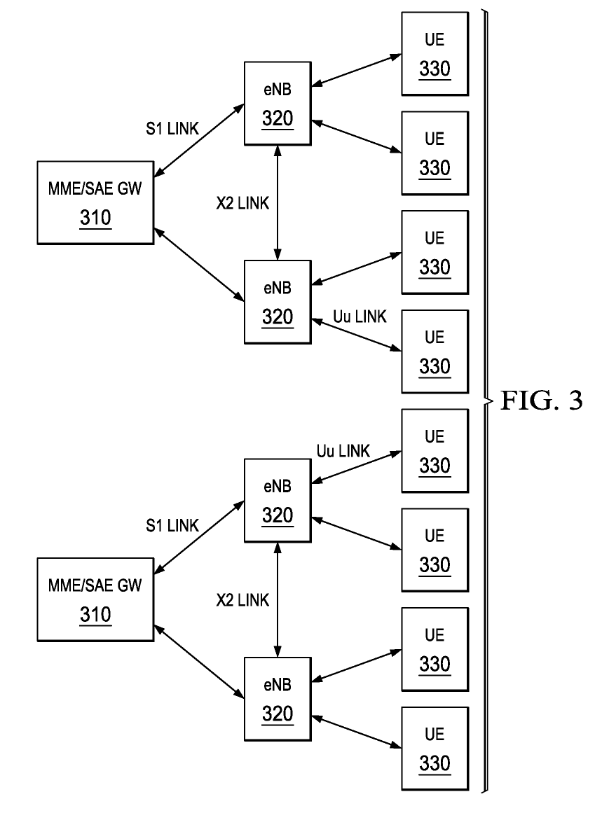

Turning now to FIG. 2, illustrated is a system level diagram of an embodiment of a communication system including wireless communication devices that provides an environment for application of the principles of the present invention. The communication system includes a base station 210 coupled by communication path or link 220 (e.g., by a fiber-optic communication path) to a core telecommunications network such as public switched telephone network (“PSTN”) 230. The base station 210 is coupled by wireless communication paths or links 240, 250 to wireless communication devices 260, 270, respectively that lie within its cellular area 290.

In operation of the communication system illustrated in FIG. 2, the base station 210 communicates with each wireless communication device 260, 270 through control and data communication resources allocated by the base station 210 over the communication paths 240, 250, respectively. The control and data communication resources may include frequency and time-slot communication resources in frequency division duplex (“FDD”) and/or time division duplex (“TDD”) communication modes.

Turning now to FIG. 3, illustrated is a system level diagram of an embodiment of a communication system including a wireless communication system that provides an environment for the application of the principles of the present invention. The wireless communication system may be configured to provide evolved UMTS terrestrial radio access network (“E-UTRAN”) universal mobile telecommunications services. A mobile management entity/system architecture evolution gateway (“MME/SAE GW,” one of which is designated 310) provides control functionality for an E-UTRAN node B (designated “eNB,” an “evolved node B,” also referred to as a “base station,” one of which is designated 320) via an S1 communication link (ones of which are designated “S1 link”). The base stations 320 communicate via X2 communication links (designated “X2 link”). The various communication links are typically fiber, microwave, or other high-frequency metallic communication paths such as coaxial links, or combinations thereof.

The base stations 320 communicate with user equipment (“UE,” ones of which are designated 330), which is typically a mobile transceiver carried by a user. Thus, communication links (designated “Uu” communication links, ones of which are designated “Uu link”) coupling the base stations 320 to the user equipment 330 are air links employing a wireless communication signal such as, for example, an orthogonal frequency division multiplex (“OFDM”) signal.

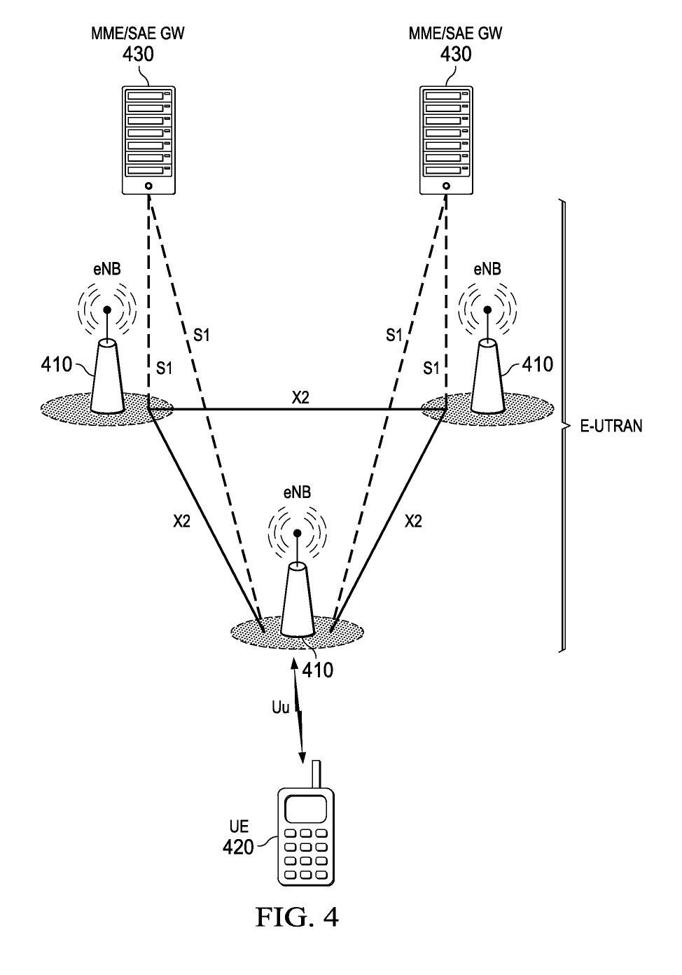

Turning now to FIG. 4, illustrated is a system level diagram of an embodiment of a communication system including a wireless communication system that provides an environment for the application of the principles of the present invention. The wireless communication system provides an E-UTRAN architecture including base stations (one of which is designated 410) providing E-UTRAN user plane (packet data convergence protocol/radio link control/media access control/physical) and control plane (radio resource control) protocol terminations towards user equipment 420. The base stations 410 are interconnected with X2 interfaces or communication links (designated “X2”). The base stations 410 are also connected by S1 interfaces or communication links (designated “S1”) to an evolved packet core (“EPC”) including a mobile management entity/system architecture evolution gateway (“MME/SAE GW,” one of which is designated 430). The S1 interface supports a multiple entity relationship between the mobile management entity/system architecture evolution gateway 430 and the base stations 410. For applications supporting inter-public land mobile handover, inter-eNB active mode mobility is supported by the mobile management entity/system architecture evolution gateway 430 relocation via the S1 interface.

The base stations 410 may host functions such as radio resource management. For instance, the base stations 410 may perform functions such as internet protocol (“IP”) header compression and encryption of user data streams, ciphering of user data streams, radio bearer control, radio admission control, connection mobility control, dynamic allocation of resources to user equipment in both the uplink and the downlink, selection of a mobility management entity at the user equipment attachment, routing of user plane data towards the user plane entity, scheduling and transmission of paging messages (originated from the mobility management entity), scheduling and transmission of broadcast information (originated from the mobility management entity or operations and maintenance), and measurement and reporting configuration for mobility and scheduling. The mobile management entity/system architecture evolution gateway 430 may host functions such as distribution of paging messages to the base stations 410, security control, termination of U-plane packets for paging reasons, switching of U-plane for support of the user equipment mobility, idle state mobility control, and system architecture evolution bearer control. The user equipment 420 receives an allocation of a group of information blocks from the base stations 410.

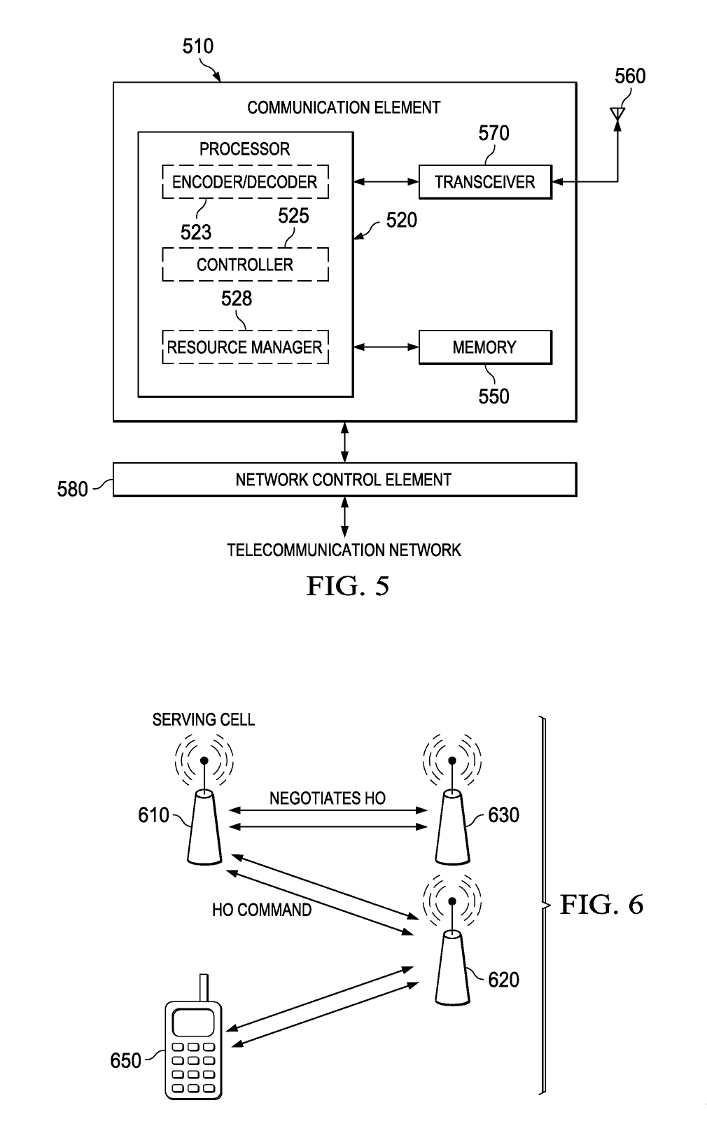

Turning now to FIG. 5, illustrated is a system level diagram of an embodiment of a communication element 510 of a communication system for application of the principles of the present invention. The communication element or device 510 may represent, without limitation, a base station, a wireless communication device (e.g., a subscriber station, terminal, mobile station, user equipment), a network control element, a communication node, or the like. The communication element 510 includes, at least, a processor 520, memory 550 that stores programs and data of a temporary or more permanent nature, an antenna 560, and a radio frequency transceiver 570 coupled to the antenna 560 and the processor 520 for bidirectional wireless communication. The communication element 510 may provide point-to-point and/or point-to-multipoint communication services.

The communication element 510, such as a base station in a cellular network, may be coupled to a communication network element, such as a network control element 580 of a public switched telecommunication network (“PSTN”). The network control element 580 may, in turn, be formed with a processor, memory, and other electronic elements (not shown). The network control element 580 generally provides access to a telecommunication network such as a PSTN. Access may be provided using fiber optic, coaxial, twisted pair, microwave communication, or similar link coupled to an appropriate link-terminating element. A communication element 510 formed as user equipment is generally a self-contained device intended to be carried by an end user.

The processor 520 in the communication element 510, which may be implemented with one or a plurality of processing devices, performs functions associated with its operation including, without limitation, encoding and decoding (encoder/decoder 523) of individual bits forming a communication message, formatting of information, and overall control (controller 525) of the communication element, including processes related to management of resources (resource manager 528). Exemplary functions related to management of resources include, without limitation, hardware installation, traffic management, performance data analysis, tracking of end users and equipment, configuration management, end user administration, management of wireless communication devices, management of tariffs, subscriptions, and billing, and the like. For instance, in accordance with the memory 550, the resource manager 528 is configured to allocate time and frequency communication resources for transmission of data to/from the communication element 510 and format messages including the communication resources therefor. The processor 520 further includes processes to manage a handover or redirection of user equipment from a serving or source base station to a target base station, such as a target base station with a closed subscriber group access restriction list.

The execution of all or portions of particular functions or processes related to management of resources may be performed in equipment separate from and/or coupled to the communication element 510, with the results of such functions or processes communicated for execution to the communication element 510. The processor 520 of the communication element 510 may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The transceiver 570 of the communication element 510 modulates information onto a carrier waveform for transmission by the communication element 510 via the antenna 560 to another communication element. The transceiver 570 demodulates information received via the antenna 560 for further processing by other communication elements. The transceiver 570 is capable of supporting duplex operation for the communication element 510.

The memory 550 of the communication element 510, as introduced above, may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 550 may include program instructions or computer program code that, when executed by an associated processor, enable the communication element to perform tasks as described herein. Of course, the memory 550 may form a data buffer for data transmitted to and from the communication element 510. Exemplary embodiments of the system, subsystems, and modules as described herein may be implemented, at least in part, by computer software executable by processors of, for instance, the wireless communication device and the base station, or by hardware, or by combinations thereof. As will become more apparent, systems, subsystems and modules may be embodied in the communication element 510 as illustrated and described herein.

Turning now to FIG. 6, illustrated is a system level communication diagram demonstrating an exemplary case of physical cell identity confusion between a serving or source cell/base station and target cells/base stations. As the user equipment 650 drifts out of the served area of a serving base station 610, the user equipment 650 measures a signal path to a candidate first target base station 620 that has a closed subscriber group access restriction list. The serving base station 610 initiates a handover command (designated “HO command”) to the first target base station 620. The handover, however, fails due to a closed subscriber group access restriction between the user equipment 650 and the first target base station 620 or for some other network related limitation. To initiate a handover of the user equipment 650 to a candidate second target base station 630, the serving base station 610 negotiates a handover (designated “Negotiates HO”) with the second target base station 630. If the second target base station 630 is designated with the same physical cell identity as the first target base station 620, an attempt by the user equipment 650 to execute the handover to the second target base station 630 may also fail due to physical cell identity confusion at the serving base station 610.

In general, the network can assign measurement gaps in the communication flow for the user equipment to enable identification of potential closed subscriber group cells or any other cell for handover. The measurement gaps are basically gaps in an uplink and downlink data transmission, which typically have higher priority than data transfer. (See, e.g., 3GPP TS 36.321, v8.5.0 (2009-03), which is incorporated herein by reference.) The current 3GPP specifications do not enable the network to assign communication gaps to the user equipment for the purpose of listening to the global cell identity (“GCID”) or the closed subscriber group identity (“CSG-ID”) of a potential handover cell. In 3GPP Release 8, listening gaps for the user equipment are assumed to be the natural gaps available during the communication stream (e.g., due to configured discontinuous reception rules provided in 3GPP TS 36.321), and hence such listening gaps are not available for all active-mode services (e.g., for voice over Internet protocol services).

Accordingly, the ability of the user equipment to further identify potential closed subscriber group cells or any other cell besides the physical cell identity for handover cannot be guaranteed, for example, during heavy data transfer or other heavy traffic. It should be understood that cell identification is generally understood as the process where the user equipment identifies a new cell (the output therefrom being the cells physical cell identity). This can be performed during the currently specified measurement gaps. The further identification of neighboring cells (e.g., reading the closed subscriber group identity and/or global cell identity) cannot be performed during the measurement gaps. Thus, it is currently not possible to solve physical cell identity confusion without the SIB 1 message in E-UTRAN in all cases without the impact as described above.

A process and method are introduced herein to realize closed subscriber group RRC_Connected mode mobility with minor changes to the current 3GPP specification and signaling. An advantageous result is a low impact on user equipment (including a low impact on user equipment design and messaging capacity) and base stations (such as in-home base stations (designated “H(e)NBs” or “in-home eNBs” such as “picocells”)), and very small or no delay in data transfer from the user equipment to the base station. The access procedure associated with a handover procedure may be modified as well as modification to the user equipment procedure description in connection with a handover to a closed subscriber group cell or any cell. As further introduced herein, the handover command from the serving base station indicates to the user equipment which access procedure to utilize.

The access procedure may follow a process as set forth below. For instance, when physical cell identity duplication, conflict or confusion is not a potential problem, the handover procedure is performed as presently defined in 3GPP technical specifications. When physical cell identity duplication or conflict may occur in macro cell(s) or in the network, the procedure introduced herein is performed.

When the user equipment receives a handover command to a closed subscriber group cell (indicated either in a handover command or is otherwise already known to the user equipment), the handover command signaled to the user equipment by the serving cell/base station provides that the user equipment should use the modified access procedure (i.e., a passive handover procedure). Using this passive handover procedure, the user equipment should not immediately access the target cell/base station on a random access channel (“RACH”) after a cell change (as currently defined), but instead would only listen to the closed subscriber group cell(s) on a physical downlink control channel (“PDCCH”) in the downlink (“DL”) (also referred to as “DL PDCCH”) for an assigned (temporary) cell radio network temporary identifier (“C-RNTI,” which is a cell-specific user equipment identifier used in a PDCCH) from the handover command. If the user equipment successfully decodes the PDCCH with a C-RNTI matching one from the handover command, the user equipment responds to the resource assignment in the PDCCH (e.g., by transmitting a random access (“RA”) burst or, if the uplink (“UL”) timing advance (“TA”) is known, data in the assigned resource on an uplink shared channel (“UL SCH”)).

Alternatively, if the user equipment successfully decodes the DL PDCCH and identifies the given C-RNTI, the user equipment will begin to access the target cell/base station on the RACH according to a conventional handover procedure. If the user equipment has not successfully decoded the PDCCH after a given time period (i.e., if the user equipment has not received and decoded a resource allocation for the given C-RNTI), the user equipment regards the target cell/base station for the handover as being incorrect and abandons the handover (e.g., by returning to the original serving cell/base station or by using other defined methods). If the handover command does not indicate that the user equipment shall use the new access method, the user equipment uses the currently defined method and begins to access the target cell/base station on the RACH immediately after a cell change.

During signaling for a handover between a serving cell/base station and a closed subscriber group target cell/base station, a dedicated, temporary C-RNTI, such as a C-RNTI assigned in a conventional RA procedure, is signaled to the user equipment. The closed subscriber group target cell/base station transmits a PDCCH assignment with the given C-RNTI, and the user equipment starts to use the C-RNTI after receiving the PDCCH from the closed subscriber group target cell/base station. If a PDCCH assignment with a C-RNTI is not received, the user equipment aborts the handover and returns to the original serving cell/base station.

When the user equipment reports a characteristic such as a signal strength of a communication path to a closed subscriber group cell(s) in a measurement report (identified by the closed subscriber group cell's physical cell identity), and the base station then begins to negotiate a handover with the closed subscriber group cell(s) (i.e., prepares the cell(s) for handover), this would follow well-established handover procedures. The target base station (in this case in the closed subscriber group cell) would assign a temporary C-RNTI (among other parameters) for the user equipment to be used during the access procedure in the target cell/base station. The user equipment and the candidate closed subscriber group cell(s)/base station(s) with which the current serving macro cell/base station has negotiated handover would be aware of the assigned C-RNTI. In case of a duplicate physical cell identity due to reuse or a conflicting closed subscriber group physical cell identity, then the network may have negotiated handover with a closed subscriber group cell different from the one the user equipment has actually identified and reported. Accordingly, the closed subscriber group cell anticipated by the user equipment for handover would not be aware of the negotiated/assigned C-RNTI. The user equipment and the closed subscriber group cell for which the handover has actually been negotiated by the base station share knowledge of the same C-RNTI for access.

When the user equipment then receives the handover command (e.g., an RRC-Connection reconfiguration message), the user equipment changes to the cell indicated in the handover command (i.e., the reported closed subscriber group cell). Due to the potential physical cell identity conflict or cell identity confusion, however, the user equipment may actually change to a different cell than the target cell/base station with which the network/base station has negotiated the handover. Due to the handover command and access procedure as introduced herein wherein the network knows that there is a risk of closed subscriber group physical cell identity conflict or confusion, the base station requests that the user equipment use the new access procedure and method in the closed subscriber group cell (or generally any target cell).

When the user equipment changes to a new serving cell/base station, the user equipment begins by listening to the DL PDCCH of the new serving cell/base station instead of immediately communicating with the new serving cell/base station on a RACH in the uplink (“UL”). The user equipment decodes the PDCCH and searches for the C-RNTI in the handover command. Only the closed subscriber group cell with which the former serving macro cell/base station actually negotiated the handover knows and uses this C-RNTI for uplink resource allocations, which the network coordinates as described below. If the user equipment changes to the same cell/base station with which the handover was negotiated, the user equipment can successfully decode the PDCCH, and the handover is made to the intended closed subscriber group cell. If the user equipment cannot successfully decode the PDCCH within a given window of time (e.g., a 10, 20 or 40 millisecond window), it can conclude that the handover was not successful, possibly due to physical cell identity confusion.

The C-RNTI is sent to the user equipment with an indication to use this passive handover procedure. The user equipment would then start by listening to the PDCCH of a cell such as a closed subscriber group cell it has been measuring and reporting for a potential resource assignment with the given C-RNTI. If the user equipment successfully decodes the PDCCH using the given C-RNTI, the user equipment regards the handover as being to the correct cell/base station. If the user equipment cannot receive the C-RNTI, however, the handover procedure is aborted, and the user equipment, for example, would return to the originally serving cell/base station.

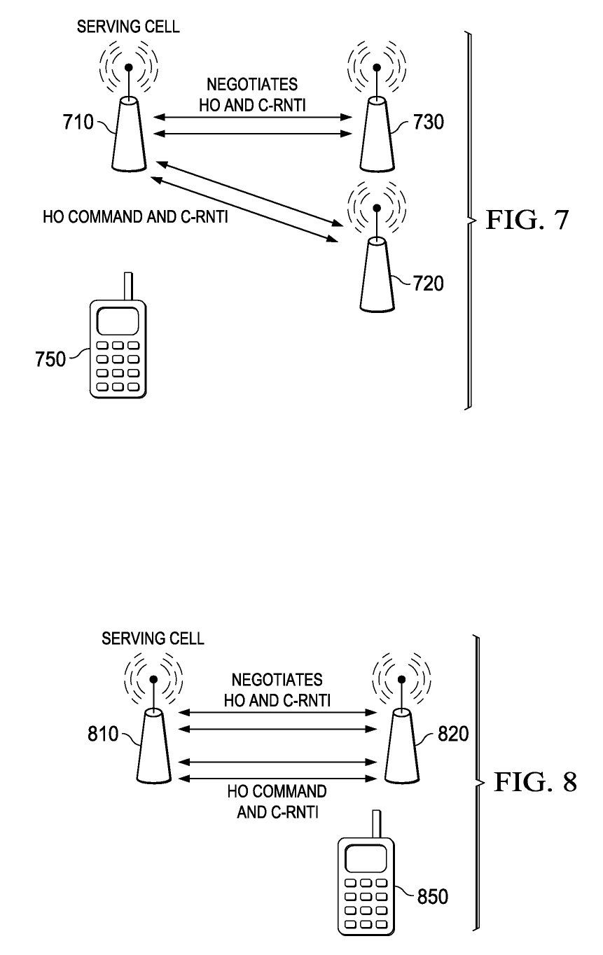

Turning now to FIG. 7, illustrated is a system level communication diagram demonstrating an exemplary case of physical cell identity confusion between a serving or source cell/base station and target cells/base stations. In this case, as the user equipment 750 drifts out of the served area of serving base station 710, the user equipment 750 again measures a signal path to a candidate first target base station 720 that is configured to operate with a closed subscriber group access restriction list. The serving base station 710 transmits a handover command and the C-RNTI (designated “HO command and C-RNTI”) to the first target base station 720. The first target base station 720 transmits a resource assignment on a PDCCH in a downlink that the user equipment 750 cannot receive. Accordingly, the first target base station 720 does not make a PDCCH resource assignment for the user equipment 750. As a result, the user equipment 750 correctly aborts the handover after it does not receive the assigned C-RNTI as a part of a resource assignment in a PDCCH from the first target base station 720. The serving base station 710 negotiates a handover and a C-RNTI (designated “Negotiates HO and C-RNTI”) with a candidate second target base station 730 that is also configured to operate with a closed subscriber group access restriction list, and also has the same physical cell identity as the first target base station 720. An attempt by the user equipment 750 to execute the handover to the second target base station 730 may also fail due to physical cell identity confusion at the serving base station 710. Thus, the user equipment 750 can abort a handover without losing connection to the serving base station 710.

An alternative to the description above, potentially with some minor added optimization to the handover procedure, would be to enable an option to assign target cell PDCCH decoding windows in a similar way to measurement gaps in the serving cell/base station. These windows could be constructed by reuse of communication gaps used for normal mobility measurement, or even a new communication gap pattern. During the assigned communication gaps, such as six milliseconds gaps, the user equipment would listen on the PDCCH of the target cell/base station. If the user equipment successfully decodes the PDCCH from the target cell/base station, the user equipment proceeds with the intended cell change.

Another alternative would be not to allocate closed subscriber group resources to the user equipment via the C-RNTI on a PDCCH during a handover procedure. Instead the handover procedure would rely on the random access procedure to be initiated and performed on a target cell's RACH by the user equipment when it recognizes the given C-RNTI. The RACH procedure at the target cell/base station would be done as currently defined in a conventional handover procedure. One benefit of this approach is that the network would not have to prepare the potential target cell/base station for the handover, and the target cell/base station would not have to reserve any resources on an uplink shared channel (“UL-SCH”) for user equipment access, which might have to be done in multiple cells in a case of physical cell identity confusion. Using this approach (i.e., using RACH instead of UL-SCH) has the additional benefit that the macro cell (the serving or source cell/base station) could actually include one or more C-RNTI(s) in the handover command (e.g., one for each cell or one common C-RNTI for multiple cells). The serving cell/base station could then inform all potential target cells/base stations about the given C-RNTI(s), and then rely on the accessed cell to perform a context fetch triggered by the user equipment responding to the C-RNTI instead of preparing multiple target cells/base stations for the handover.

Alternatively, this approach could also be combined with the use of a dedicated preamble for RACH. Combining the dedicated preamble would improve the procedure even further by reducing potential conflict with C-RNTIs already used in the target cell/base station in the case that the network does not check used or occupied C-RNTIs in the target cell/base station prior to issuing a handover command. The network could then reserve a number of RACH preambles for this purpose, which would then not be used by user equipments already in the target cell/base station.

Concerning C-RNTI reservations among closed subscriber group cells or other cells, when using this procedure, with potentially duplicate physical cell identities (i.e., closed subscriber group cells or other cells using the same physical cell identity within a given area such as a macro cell), C-RNTI reservations could be made with coordination at the network level. An example would be that potentially conflicting (or all) closed subscriber group cells are assigned distinct C-RNTI address spaces within the full C-RNTI address space. Another example would be that the network does this through use of some in-home base station gateway (“GW”). A further non-limiting example would be to reserve certain distinct C-RNTIs specifically for this purpose. Additionally, the serving or source base station would not be reset (i.e., the user equipment configuration is kept until after the serving base station has received a “handover complete” message from a target base station at, for instance, the time when the handover process would do path switching for routing).

Turning now to FIG. 8, illustrated is a system level communication diagram demonstrating an exemplary case of physical cell identity confusion between a serving or source cell/base station and target cells/base stations. In this case, as the user equipment 850 drifts out of the served area of serving base station 810, the user equipment 850 measures a signal path to a target base station 820 that is configured to operate with a closed subscriber group access restriction list. The serving base station 810 negotiates a handover and a C-RNTI (designated “Negotiates HO and C-RNTI”) with the target base station 820. The serving base station 810 transmits a handover command and the C-RNTI (designated “HO command and C-RNTI”) to the target base station 820. The target base station 820 transmits a resource assignment on a PDCCH to the user equipment 850 in a downlink that the user equipment 850 correctly receives. As a result, the user equipment 850 and the serving base station 810 both have a correct understanding of the closed subscriber group cell. Thus, the user equipment 850 can correctly execute the handover to the target base station 820. Thus, the access procedure illustrated in FIG. 8 demonstrates a consequence of managing physical cell identity confusion, wherein the handover starts immediately once the user equipment 850 receives the PDCCH assignment.

Thus as introduced herein, recovery from and management of physical cell identity confusion may be enabled with little or no interruption to ongoing service. A faster handover to a cell in a closed subscriber group may be performed when the correct closed subscriber group cell is detected. The physical cell identity confusion is not completely removed, but rapid recovery from physical cell identity confusion is enabled. It should be understood that while many of the exemplary embodiments refer to closed subscribed group cells, the principles of the present invention apply to all types of cells in a communication system.

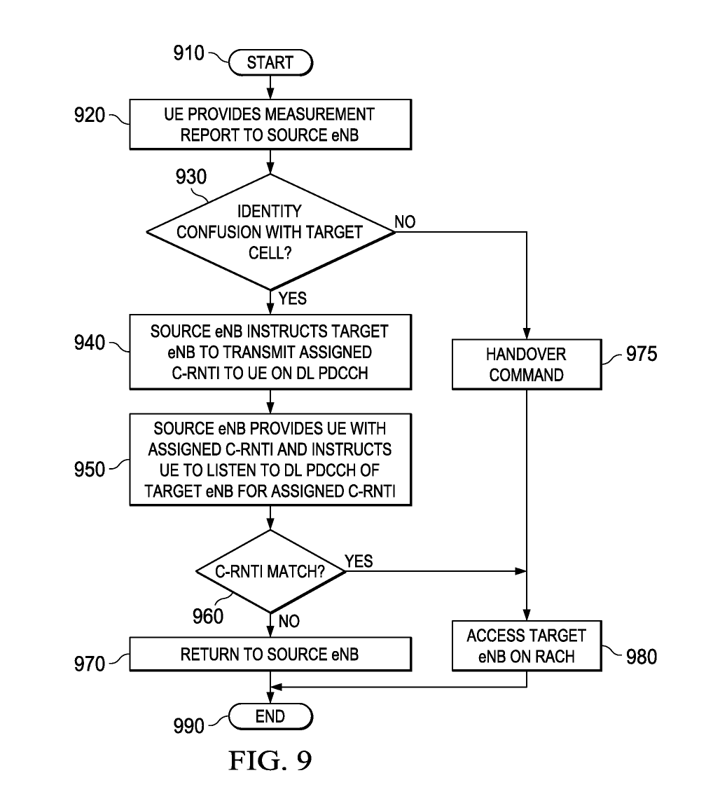

Turning now to FIG. 9, illustrated is a flow diagram of an embodiment of a sequence of operations performed to execute a handover to a target base station according to the principles of the present invention. The access procedure starts at step or module 910. In a step or module 920, the user equipment provides a measurement report including a physical cell identity of a target cell to serving or source base station. In a step or module 930, the source base station determines if there is identity confusion (e.g., physical cell identity confusion) with the target cell. Additionally, the source base station may request additional information about the target cell (especially in the case of uncoordinated cell deployment) to ascertain the level of identity confusion. If there is no identity confusion, the source base station instructs the user equipment to access a target base station in the target cell (e.g., in accordance with a handover command, indicated in a step or module 975), the user equipment accesses the target base station on, for instance, a RACH as indicated in a step or module 980, and the process ends at a step or module 990. If there is identity confusion, the source base station instructs the target base station to provide an assigned C-RNTI and to begin transmitting the assigned C-RNTI on a DL PDCCH to the user equipment, as illustrated in a step or module 940. The source base station also provides the assigned C-RNTI to the user equipment and further instructs the user equipment to listen to the target base station on the DL PDCCH for the assigned C-RNTI (e.g., in accordance with a handover command), as illustrated in a step or module 950.

At a step or module 960, the user equipment compares the C-RNTIs received from the source base station and the DL PDCCH associated with the target base station. If the C-RNTIs match, the user equipment accesses the target base station on, for instance, a RACH, as indicated in a step or module 980, and the process ends at a step or module 990. If the C-RNTIs do not match, the user equipment returns to the source base station and another handover procedure is performed, as illustrated in a step or module 970, and the process ends at the step or module 990.

In addition to the steps mentioned above, an additional step or module may be inserted to ascertain if the target base station is part of group of base stations with a closed subscriber group access restriction list in accordance with the user equipment. Depending on the access restriction associated with the target base station, the handover of the user equipment may be performed as mentioned above. Of course, other steps or modules may be added or ones of the steps or modules provided herein may be omitted and still fall within the broad scope of the present invention.

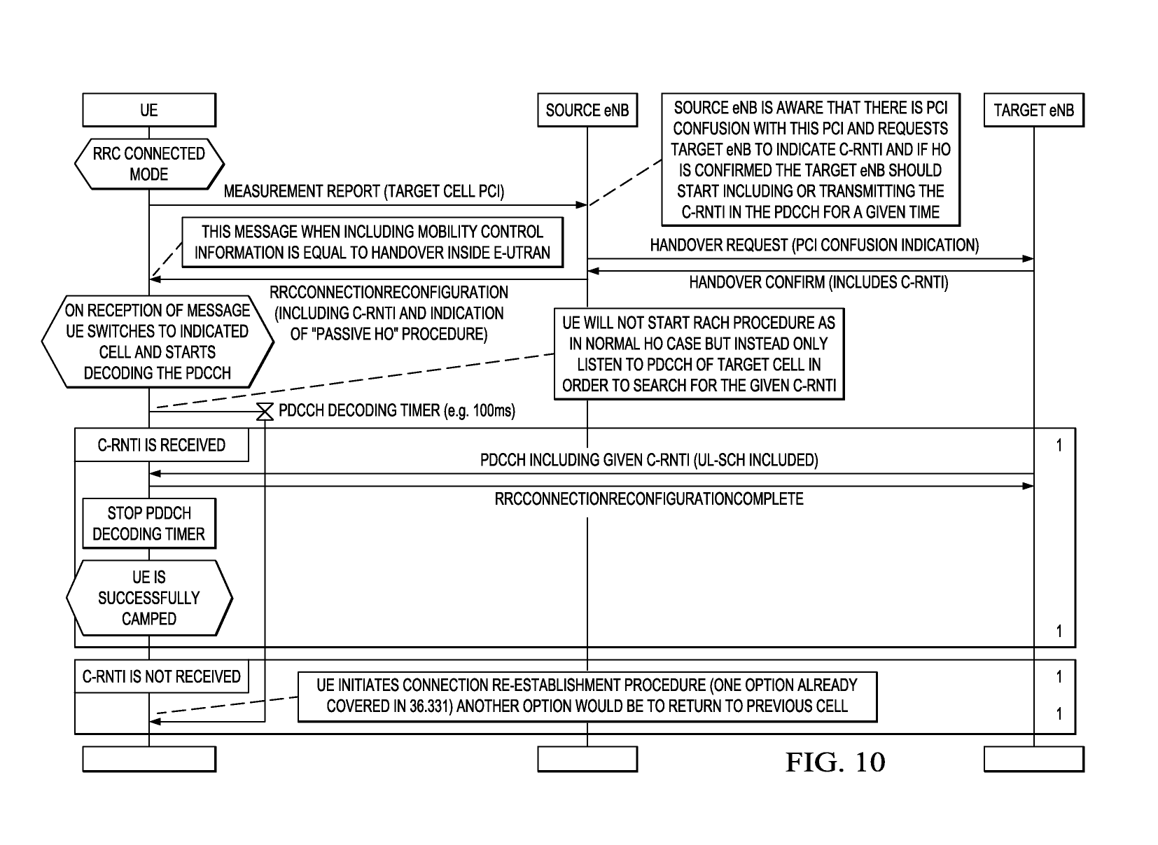

Turning now to FIG. 10, illustrated is a signaling diagram demonstrating exemplary signaling messages between user equipment (designated “UE”), a serving or source base station (designated “source eNB”) and a target base station (designated “target eNB”) during a handover procedure in accordance with the principles of the present invention. The user equipment initially employs the source base station in an RRC_Connected mode. The user equipment transmits a measurement report to the source base station including a characteristic of a communication path for a potential handover to a target base station identified by a physical cell identity (“PCI”). The source base station is aware that there is physical cell identity confusion and transmits a handover request to the target base station, and identifies physical cell identity confusion. The target base station confirms handover to the source base station including a C-RNTI in the PDCCH for a given time.

The source base station then transmits an RRC_Connection reconfiguration message to the user equipment, including the C-RNTI and indication of a passive handover procedure. When the message from the source base station to the user equipment includes mobility control information is analogous to the handover procedure in accordance with an E-UTRAN. On reception of the message from the source base station, the user equipment listens to the indicated target base station and starts decoding the PDCCH instead of following a random access procedure. The user equipment starts a PDCCH decoding timer, for example, a 100 millisecond timer. If the user equipment receives the C-RNTI and a PDCCH from the target base station matching the previously identified C-RNTI, the user equipment stops the PDCCH decoding timer. The user equipment has now successfully transferred to the target base station. If the user equipment did not receive the C-RNTI from the source base station, the user equipment recognizes failure of the handover process and initiates connection reestablishment with the source base station (see, e.g., 3GPP TS 36.331). It should be understood that the user equipment may also initiate a random access procedure as described above.

Thus, a system and method has been introduced to provide handover or redirection of user equipment in a communication system wherein a target cell cannot be uniquely identified (e.g., physical cell identity confusion). In one embodiment, the present invention provides an apparatus (e.g., user equipment) including a processor configured to receive a command identifying confusion (e.g., physical cell identity confusion) with a target cell, and to enable a transceiver of the user equipment to listen to a target base station of the target cell on a PDCCH for an assigned C-RNTI in accordance with the command. The processor is also configured to determine if a C-RNTI received from a source base station matches the assigned C-RNTI received from the target base station. The processor is still further configured to control the transceiver to access the target base station on a RACH, if the C-RNTI received from the source base station matches the assigned C-RNTI received from the target base station.

In another embodiment, the present invention provides an apparatus (e.g., a base station) including a processor configured to determine if there is identity confusion (e.g., physical cell identity confusion) with a target cell associated with the target base station. If there is identify confusion with the target cell, the processor is configured to instruct the target base station to provide an assigned C-RNTI and to begin transmitting the assigned C-RNTI on a DL PDCCH to user equipment. The processor is also configured to provide the assigned C-RNTI to the user equipment and further instructs the user equipment to listen to the target base station on the DL PDCCH for the assigned C-RNTI. If the C-RNTI from the base station does not match the assigned C-RNTI on the DL PDCCH from the target base station, the processor is configured to reestablish connection with the user equipment or the user equipment reestablishes reconnection with the base station.

In another aspect, a process and method are introduced to enable a communication network to uniquely identify (target handover) cells reported by user equipment. The user equipment, in addition to the currently reported physical cell identity of cells identified as handover targets, also reports a specific C-RNTI read from an identified and reported neighboring cell's PDCCH. Cell identification is supported by optionally adding a C-RNTI such that this enhanced cell identification procedure includes reading of a C-RNTI in addition to the current primary scrambling code/secondary scrambling code (“PSC/SSC”) from neighboring cells, and including the C-RNTI in addition to the currently reported primary scrambling code/secondary scrambling code physical cell identity in the measurement report. For instance, the physical cell identity can deduced from the primary scrambling code/secondary scrambling codes during a cell identification procedure, and the physical cell identity may be included in the measurement report.

The additional reading of cell C-RNTI from neighbor cells could be configurable and controllable by the network. The network may assist the user equipment in the process by informing the user equipment about the bandwidth (“BW”) of inter-frequency or inter-radio access technology (“RAT”) carriers used in mobility (when needed). This is not viewed as a necessity or a limiting factor. The process introduced herein may be applied prior to actual handover execution (i.e., prior to a serving or source base station sending a handover command to the user equipment). The procedures may be realized in different forms. First, the procedures can be applied to E-UTRAN and closed subscriber group cells as a nonlimiting exemplary case. The process can be expanded to cover a network with uncoordinated deployment or potential problems with unique identification of one or more cells used in mobility. The process may be expanded to be operative with other communication systems such as LTE-Advanced (“LTE-A”).

When user equipment in a RRC_Connected mode is configured to provide channel measurements to neighboring cells (for example, as described in 3GPP TS 36.331, v8.5.0 (2009-03), which is incorporated herein by reference), basic closed subscriber group information is included such as closed subscriber group-physical identity cell range. (See, e.g., U.S. patent application Ser. No. 61/210,784, entitled “Measurement Configuration and Reporting of CSG cells in Connected Mode,” filed Mar. 23, 2009, which serve as priority document for PCT Application Serial No. PCT/IB2010/000653, filed Mar. 23, 2010, all of which are incorporated herein by reference). As introduced herein, the base station also enables the user equipment to decode the PDCCH of specific or all neighboring cells and to search for a certain given or known C-RNTI(s) on cells with a given, specific physical cell identity. The base station enables the user equipment to perform this process using a measurement configuration or similar message, or a broadcast message.

Alternatively, the user equipment may be configured to perform channel measurements on neighboring cells as currently specified in 3GPP TS Release 8 (see 3GPP TS 36.331, Section 5.5), and to report cells identified as targets for a handover according to current rules. It is noted that no special rules presently exist on user equipment reporting channel measurements for closed subscribed group cells. When a base station receives a measurement report from the user equipment and determines that the base station needs more information from a potential handover candidate target cell/base station in order to be able to uniquely determine which cell the physical cell identity identifies, the base station orders the user equipment to read the PDCCH of the cell in question and search for one or more given C-RNTIs in the PDCCH. If or when the user equipment decodes the PDCCH of the cell in question, it reports to the network which of the given C-RNTIs was successfully decoded in the PDCCH from the cell.

This procedure can be realized in E-UTRAN with backwards compatibility with legacy (Release 8) user equipment, for example, by the following action. First, by indicating to the user equipment to report this additional information from cells within a given physical cell identity range. The C-RNTI to search by the user equipment would be given by the serving or source base station and potentially linked to a reported physical cell identity. Second, introducing a potentially new message that the network can use to direct the user equipment to read additional C-RNTI information from a given cell (identified by the reported PCI). The C-RNTI to search for is given in the command (i.e., a similar approach as used for automatic neighbor relation (“ANR”) and reporting of cells cell global identity (report cell global identity) procedure in E-UTRAN 3GPP TS Release 8 (3GPP TS 36.331 Section 5.5)).

In a more general process, the base station orders the user equipment to decode the PDCCH of any target/neighboring cells and search for a given set of C-RNTIs. When the user equipment has decoded the PDCCH from a target cell with a physical cell identity on the given list, the user equipment will search the PDCCH of that cell for one of the C-RNTIs listed with the given physical cell identity. The user equipment then reports the identified C-RNTI to the network. The network now has the physical cell identity and C-RNTI of the given cell that in practice reduces the physical cell identity confusion probability substantially.

The process is not being limited to reading this additional cell information or identification from the PDCCH of a given cell. Generally the process should be covering the user equipment reading an additional short identification (e.g., number) from a neighboring cell. This additional information would be transmitted such that either it is sent often enough for the user equipment to receive the information using the same as currently defined measurement gap pattern (or modified gap pattern but with very short interruption time in potential data transmission in a source cell) or the timing when it is transmitted should be known by the user equipment (and reading it potentially coordinated by or with the network or base station). This information could then be transmitted on the center bandwidth of the cell (not necessarily requiring the full bandwidth of the cell) in a manner similar to the transmission of the primary scrambling code/secondary scrambling codes on the center bandwidth of the cell.

A reason not to limit the process only to C-RNTI as described in LTE Release 8, but potentially use a new more robust format is the fact that the probability of decoding error on PDCCH in Release 8 is about one percent. If a more robust signaling method or potentially a new PDCCH format or coding with lower decoding error rate is employed, this would improve the process. The idea is not directly limited to C-RNTI decoding of a neighboring cell. It is noted that the process should not be limited to using PDCCH as the downlink signaling method and utilizing the full bandwidth of the cell, which may be advantageous, but the process could also be realized using a new message on the center bandwidth of cell, such as used for PSC and SSC signaling. As mentioned above, it should be understood that while many of the exemplary embodiments refer to closed subscribed group cells, the principles of the present invention apply to all types of cells in a communication system.

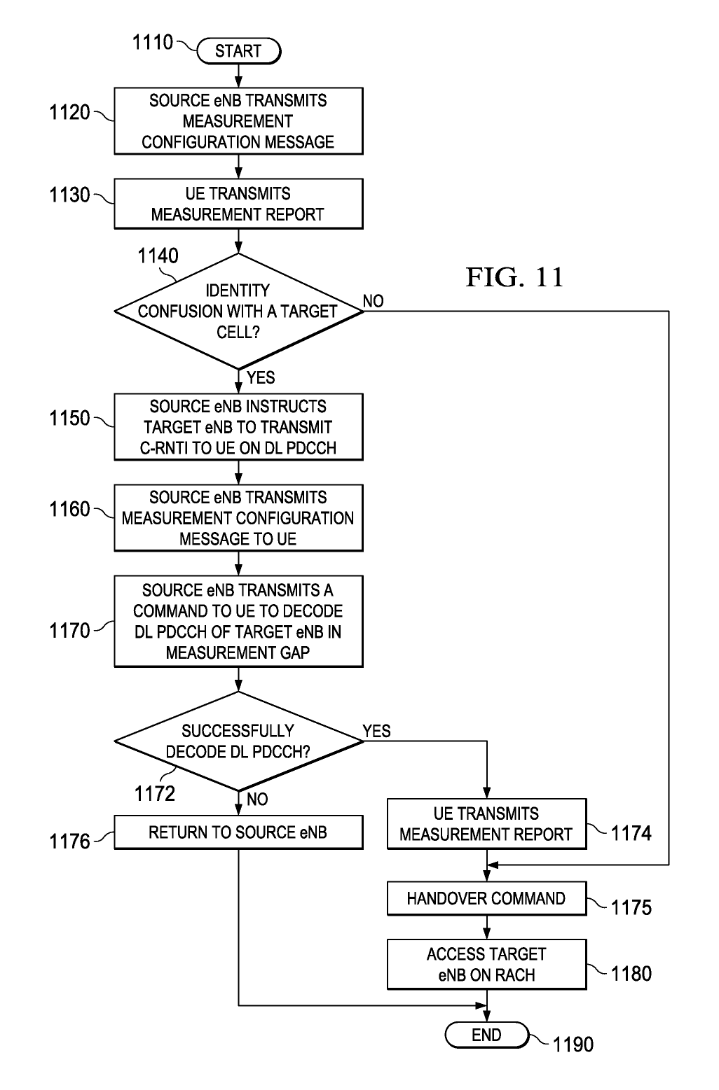

Turning now to FIG. 11, illustrated is a flow diagram of an embodiment of a sequence of operations performed to execute a handover to a target base station according to the principles of the present invention. The access procedure starts at a step or module 1110. In a step or module 1120, the source base station transmits a measurement configuration message to the user equipment providing measurement rules and reporting events. The measurement configuration message may also define transmission measurement gaps to enable the user equipment to switch to a target base station frequency and to search for potential target cell(s). In a step or module 1130, the user equipment transmits a measurement report to the source base station including the physical cell identities of identified target cell(s).

In a step or module 1140, based on the measurement report, the source base station determines if there is identity confusion (e.g., physical cell identity confusion) with a target cell. Additionally, the source base station may request additional information about the target cell (especially in the case of uncoordinated cell deployment) to ascertain the level of identity confusion or for some other purpose. If there is no identity confusion, the source base station may instruct the user equipment to access a target base station in a target cell (e.g., in accordance with a handover command, as indicated in a step 1175) and the user equipment accesses the target base station on, for instance, a RACH, as indicated in a step or module 1180, and the process ends at a step or module 1190. If there is identity confusion or a potential therefor, the source base station instructs the target base station to provide a C-RNTI and to begin transmitting the C-RNTI on a DL PDCCH to the user equipment, as illustrated in a step or module 1150. The source base station also transmits a measurement configuration message or other message to the user equipment including the physical cell identity of the target cell and C-RNTI, as illustrated in a step or module 1160. The source base station also transmits a command to the user equipment to decode the DL PDCCH of the target cell using the configured measurement gap to search for the C-RNTI, as illustrated in a step or module 1170. Alternatively, the user equipment may use natural gaps in a data transmission or communication stream (e.g., due to configured discontinuous reception as provided in 3GPP TS 36.321, Section 5.7) to decode the DL PDCCH of the target cell.

In a step or module 1172, it is determined if the user equipment successfully decodes the DL PDCCH and finds the C-RNTI of the target cell. If the user equipment successfully decodes the DL PDCCH and finds the C-RNTI of the target cell, a measurement report is transmitted to the source base station including the physical cell identity and the C-RNTI of the target cell, as illustrated in a step or module 1174. The source base station can thereafter initiate a handover (e.g., in accordance with a handover command, as indicated in a step 1175) and the user equipment accesses the target base station on, for instance, a RACH, as indicated in step or module 1180, and the process ends at a step or module 1190. If the user equipment cannot successfully decodes the DL PDCCH, the user equipment may report the same to the source base station and another handover procedure is performed, as illustrated in a step or module 1176, and the process ends at the step or module 1190.

In addition to the steps mentioned above, an additional step or module may be inserted to ascertain if the target base station is part of group of base stations with a closed subscriber group access restriction list in accordance with the user equipment. Depending on the access restriction associated with the target base station, the handover of the user equipment may be performed as mentioned above. Of course, other steps or modules may be added or ones of the steps or modules provided herein may be omitted and still fall within the broad scope of the present invention.

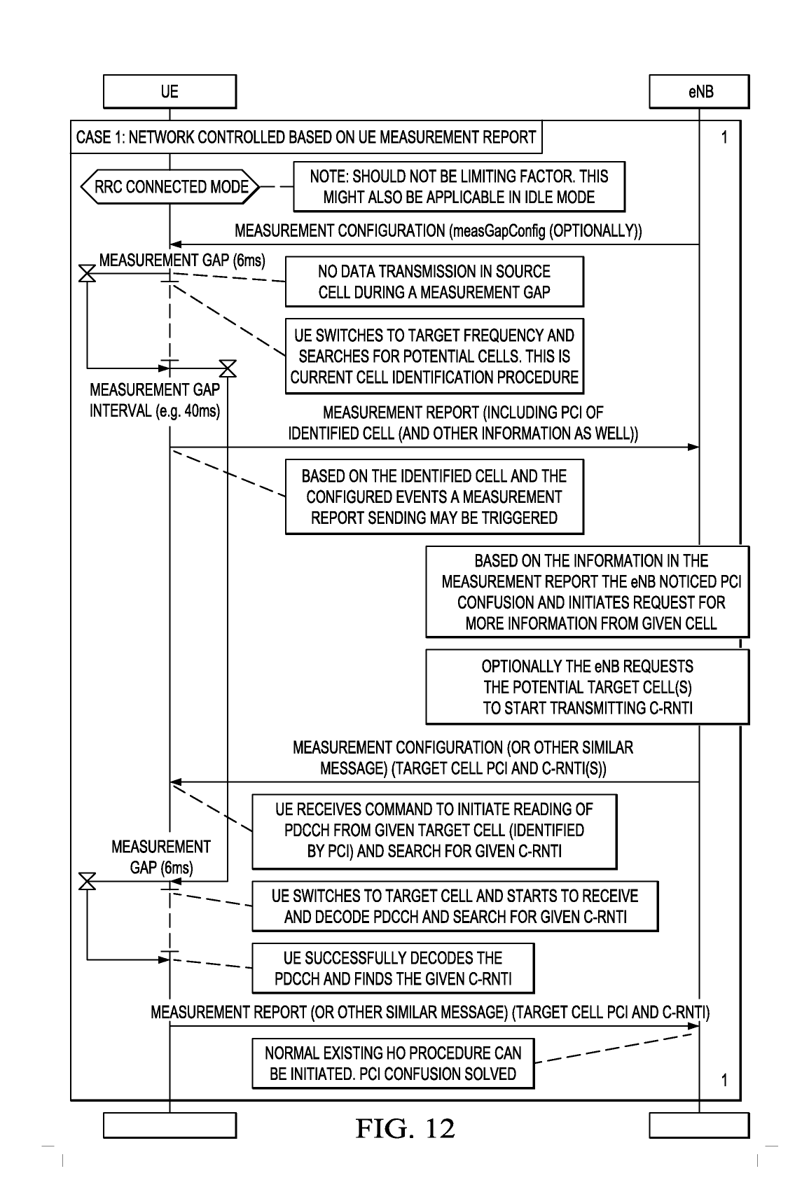

Turning now to FIG. 12, illustrated is a signaling diagram demonstrating exemplary signaling messages between user equipment (designated “UE”) and a serving or source base station (designated “eNB”) during a handover procedure in accordance with the principles of the present invention. The illustrated embodiment demonstrates a network managed handover in accordance with a measurement report from a user equipment. The user equipment is initially on the source base station in an RRC_Connected mode (e.g., the user equipment may also be in an idle communication mode). The source base station transmits a measurement configuration message to the user equipment instructing the use equipment on measurement criteria/rules, reporting events, etc (see, e.g., 3GPP TS 36.331 Section 5.5). A transmission measurement gap, such as a six millisecond measurement gap, may be established by the source base station that enables the user equipment to switch to a target base station frequency and to search for potential target cell(s) for handover. The transmission measurement gap for no data transmission may use defined gap patterns for this purpose as well and may be configured by the source base station for use, activation and deactivation.

The user equipment transmits a measurement report to the source base station including the physical cell identity (“PCI”) of identified target cell(s) as well as other data (such as the configured events). Based on information in the measurement report, the source base station determines the opportunity for physical cell identity confusion or there is a need for further identification of identified target cell(s) and initiates a request for more information from the user equipment related to one or more target base station(s)/cell(s). Optionally, the source base station may request the potential target base station to transmit a C-RNTI. The source base station transmits a measurement configuration message or other message to the user equipment including the physical cell identity of the target cell and C-RNTI(s). The user equipment receives a command from the source base station to initiate reading of the PDCCH of the target base station that was identified by the physical cell identity, and to search the PDCCH for the given C-RNTI. A (new) measurement gap, such as a six millisecond measurement gap with the 40 or 80 millisecond interval or periodicity, is established during which the user equipment listens to the target base station and starts to receive and decode its PDCCH and to search for the given C-RNTI. If the user equipment successfully decodes the PDCCH and finds the given C-RNTI, a measurement report is transmitted to the source base station including the target base station physical cell identity and the C-RNTI. At this point, a normal handover procedure (as currently defined) using RACH access handover procedure can be initiated by the source base station without physical cell identity confusion.

The process can be applied to LTE-A and to the potential increase in uncoordinated deployment or intra-cell component carrier (“CC”) identification. For uncoordinated deployment, the approach can be similar to that described above. For intra-cell component carrier identification, the network would indicate which cells with which C-RNTI are to be considered as intra-cell. Thus, an embodiment of the process enables removal or substantial reduction of physical cell identity confusion in a handover process. It is applied prior to a handover procedure (prior to a source base station sending a handover command to user equipment). The approach is less complex than other alternatives, and enables reuse of existing 3GPP Release 8 components, which can be realized with minor impact and implementation effort. The impact of the process on the network can be minimized and controlled by the network to situations where physical cell identity confusion is an important issue. The procedures can also be incorporated in the 3GPP cellular system with backwards compatibility. An embodiment of the procedures can be used for cells with a closed subscriber group access restriction list, as well as less coordinated network deployments. It can be used in LTE-A system designs. The procedures can also be applied using existing measurement gap patterns and with the existing interruption times.

Thus, a system and method has been introduced to provide handover or redirection of user equipment in a communication system wherein a target cell cannot be uniquely identified (e.g., physical cell identity confusion). In one embodiment, the present invention provides an apparatus (e.g., user equipment) including a processor configured to receive a first message (e.g., a measurement configuration message) defining measurements and potentially transmission measurement gaps (in accordance with transmission measurement gap patterns) to enable the user equipment to switch to a frequency to search for target cells. The processor is also configured to generate a first report (e.g., a measurement report) for a source base station including physical cell identities of identified target cells. The processor is also configured to receive a second message (e.g., a measurement configuration message) including the physical cell identity of the target cell and a C-RNTI, and a command to initiate decoding of a DL PDCCH of the target cell in for instance, a transmission measurement gap or natural transmission gaps to search for the C-RNTI. If the user equipment successfully decodes the DL PDCCH and finds the C-RNTI of the target cell, the processor is configured to generate a second report (e.g., a measurement report) for transmission to the source base station including the physical cell identity and the C-RNTI of the target cell.

In another embodiment, the present invention provides an apparatus (e.g., a base station) including a processor configured to generate a first message (e.g., a measurement configuration message) defining a transmission measurement gap (in accordance with transmission measurement gap patterns) to enable user equipment to switch to a frequency to search for target cells. The processor is also configured to receive a first report (e.g., a measurement report) from the user equipment including physical cell identities of the target cells. Based on the first report, the processor is configured to determine if there is identity confusion (e.g., physical cell identity confusion) with a target cell or other need for further identification of a target cell. If there is identity confusion or other need for further identification of a target cell, the processor is configured to instruct a transceiver of the base station to instruct a target base station in the target cell to provide a C-RNTI and to begin transmitting the C-RNTI on a DL PDCCH to the user equipment. The processor is also configured to generate a second message (e.g., a measurement configuration message) for the user equipment including the physical cell identity of the target cell and the C-RNTI, and a command for the user equipment to initiate decoding of a DL PDCCH of the target cell in the transmission measurement gap or a natural transmission gap to search for the C-RNTI. If the user equipment successfully decodes the DL PDCCH and finds the C-RNTI of the target cell, the processor is configured to receive a second report (e.g., a measurement report) including the target base station physical cell identity and the C-RNTI. The processor may also receive the second report if the user equipment cannot successfully decode the DL PDCCH.

Embodiments of processes introduced herein may take advantage of existing procedures and messages described in 3GPP technical specifications, and provide added information elements (“IEs”) in relevant messages (e.g., handover and redirection messages). Besides including additional information elements in the related messages, some changes may be made to the procedural description for user equipment actions related to handling these messages.

Program or code segments making up the various embodiments of the present invention may be stored in a computer readable medium or transmitted by a computer data signal embodied in a carrier wave, or a signal modulated by a carrier, over a transmission medium. For example, a computer program product including program code stored in computer readable medium may form various embodiments of the present invention. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, an optical disk, a hard disk, a fiber optic medium, a radio frequency (“RF”) link, and the like. The computer data signal may include any signal that can propagate over a transmission medium such as electronic communication network channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, added, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus, comprising:
a processor; and
memory including computer program code
said memory and said computer program code configured to, with said processor, cause said apparatus to perform at least the following:
receive a command from a source base instructing said apparatus to decode a physical downlink control channel associated with a target base station; and
determine if a cell radio network temporary identifier from said source base station matches an assigned cell radio network temporary identifier on said physical downlink control channel from said target base station.

2. The apparatus as recited in claim 1 wherein said memory and said computer program code is configured to, with said processor, cause said apparatus to provide a measurement report identifying said target base station.

3. The apparatus as recited in claim 1 wherein said memory and said computer program code is configured to, with said processor, cause said apparatus to access said target base station on a random access channel when said cell radio network temporary identifier from said source base station matches said assigned cell radio network temporary identifier on said physical downlink control channel from said target base station.

4. The apparatus as recited in claim 1 wherein said memory and said computer program code is configured to, with said processor, cause said apparatus to access said target base station via physical downlink control channel assigned resources in an uplink with a random access channel burst or with data when said cell radio network temporary identifier from said source base station matches said assigned cell radio network temporary identifier on said physical downlink control channel from said target base station.

5. The apparatus as recited in claim 1 wherein said memory and said computer program code is configured to, with said processor, cause said apparatus to decode said physical downlink control channel associated with said target base station during a measurement gap in data transmissions thereto.

6. A method, comprising:
receiving a command from a source base instructing said apparatus to decode a physical downlink control channel associated with a target base station; and
determining if a cell radio network temporary identifier from said source base station matches an assigned cell radio network temporary identifier on said physical downlink control channel from said target base station.

7. The method as recited in claim 6 further comprising providing a measurement report identifying said target base station.

8. The method as recited in claim 6 further comprising accessing said target base station on a random access channel when said cell radio network temporary identifier from said source base station matches said assigned cell radio network temporary identifier on said physical downlink control channel from said target base station.

9. The method as recited in claim 6 further comprising accessing said target base station via physical downlink control channel assigned resources in an uplink with a random access channel burst or with data when said cell radio network temporary identifier from said source base station matches said assigned cell radio network temporary identifier on said physical downlink control channel from said target base station.

10. The method as recited in claim 6 further comprising decoding said physical downlink control channel associated with said target base station during a measurement gap in data transmissions thereto.

11. An apparatus, comprising:
a processor; and
memory including computer program code
said memory and said computer program code configured to, with said processor, cause said apparatus to perform at least the following:
instruct a target base station to transmit an assigned cell radio network temporary identifier on said physical downlink control channel to a user equipment; and
provide a command instructing a user equipment to decode said physical downlink control channel to determine if a cell radio network temporary identifier in said command matches said assigned cell radio network temporary identifier.

12. The apparatus as recited in claim 11 wherein said memory and said computer program code is configured to, with said processor, cause said apparatus to receive a measurement report from said user equipment identifying said target base station.

13. The apparatus as recited in claim 11 wherein said command is further configured to instruct said user equipment to access said target base station on a random access channel when said cell radio network temporary identifier therein matches said assigned cell radio network temporary identifier.

14. The apparatus as recited in claim 11 wherein said command is further configured to instruct said user equipment to access said target base station via physical downlink control channel assigned resources in an uplink with a random access channel burst or with data when said cell radio network temporary identifier therein matches said assigned cell radio network temporary identifier.

15. The apparatus as recited in claim 11 wherein said command is further configured to instruct said user equipment to decode said physical downlink control channel during a measurement gap in data transmissions thereto.

16. A method, comprising:
instructing a target base station to transmit an assigned cell radio network temporary identifier on said physical downlink control channel to a user equipment; and
providing a command instructing a user equipment to decode said physical downlink control channel to determine if a cell radio network temporary identifier in said command matches said assigned cell radio network temporary identifier.

17. The method as recited in claim 16 further comprising receiving a measurement report from said user equipment identifying said target base station.

18. The method as recited in claim 16 further comprising instructing said user equipment to access said target base station on a random access channel when said cell radio network temporary identifier therein matches said assigned cell radio network temporary identifier.

19. The method as recited in claim 16 further comprising instructing said user equipment to access said target base station via physical downlink control channel assigned resources in an uplink with a random access channel burst or with data when said cell radio network temporary identifier therein matches said assigned cell radio network temporary identifier.

20. The method as recited in claim 16 further comprising instructing said user equipment to decode said physical downlink control channel during a measurement gap in data transmissions thereto.
